(19) United States
(12) Patent Application Publication
(10) Pub. No.: US 2009/0030816 A1
(43) Pub. Date: Jan. 29, 2009

(54) Method, computer program, warehouse management system, billing process and web interface to provide collection, storage and delivery service to individuals

(76) Inventor: John Van Meter, Celebration, FL (US)

Correspondence Address: TODD S. PARKHURST;HUGHES SOCOL PIERS RESNICK & DYM LTD., THREE FIRST NATIONAL PLAZA, 70 WEST MADISON- SUITE 4000, CHICAGO, IL, 60602, US

(21) Appl. No.: 11/430,402

(22) Filed: May 9, 2006

Related U.S. Application Data
(60) Provisional application No. 60/679,520, filed on May 10, 2005.

(51) Int. Cl. G06Q 10/00

(52) U.S. Cl. 705/28; 705/1

(57) ABSTRACT

A method for receiving, storing, retrieving and delivering a container is presented. The container may contain a client's personal items, and the method may be used by clients who periodically stay at a resort, for example. The method automates the attendant storage or warehouse management, billing system, and container pickup and delivery scheduling among others activities.

This application claims priority from U.S. Provisional Application Ser. No. 60/679,520, Filed May 10, 2006.

### BACKGROUND OF THE INVENTION

1. Field of the Invention

The present invention relates to a web-based service which allows time-share owners, and other frequent visitors, to enroll in a service that will collect personal items when desired, store them, and then re-deliver them when requested. The invention will permit clients to notify Owner's Locker when to deliver and pick up their items and includes a warehouse management system that accurately tracks the whereabouts of their personal items at all times.

2. Description of the Prior Art

Timeshare ownership is extremely popular and is growing rapidly. Major companies have entered the market, lending it credibility, and have developed increasingly flexible programs to allow their timeshare owners more choice on when and how often they may use their vacation home. Some even allow owners to choose the size of the accommodation for each visit. Many timeshare owners have always thought of their ownership with a resort company as an alternative to a second home. With the major companies' involvement and added flexibility, the number of timeshare owners who think of their ownership as being akin to a second home continues to increase.

A major attribute to a second home is the ability to keep personal items in the home so that they do not have to be carried back and forth with each visit. If the individual is the sole owner of the property this is easy to accomplish. Even if the vacation home is rented out part of the time, there has traditionally been an “owner's closet” where the personal items of the owner can be safely stored. A typical timeshare unit has 50 owners making on-site storage a practical impossibility. Up until now, there has been no convenient way for timeshare owners to store personal items between visits. Some of the large resort companies have addressed this issue with their high-end timeshare resorts where each unit has 10 owners or less (rather than the usual 50). One company has an off-site storage warehouse for its units that have four to six owners each and another resort company has built 10 separate storage areas for their units that have only 10 owners.

Up until this invention, timeshare owners have only had the choice of hauling personal items back and forth for each visit or renting personal storage space somewhere off-site from their vacation home. The new service of which this invention consists provides a portable container to the timeshare owner in which they place the items they would like to have at hand during their visit to their vacation home. Timeshare owners subscribe to the service via the Owner's Locker website and also use the website to pay for their container and notify us when they are going to arrive and depart so that their personal items can be delivered and picked up.

There currently is no other company that provides this service. There are storage companies that will deliver very large empty containers and return to pick them up when it is filled; and then take it to a warehouse until they are asked to re-deliver it. These containers are designed to hold large items such as furniture and require the use of a forklift to move. These companies' services are not web based and this service is typically used only one time by an individual. These containers are also far too large to be used by timeshare owners and would likely not be allowed into the resorts.

In view of the foregoing, it is an object of the present invention to provide a method and computer program for retrieving, delivering and storing individuals' personal items on request.

### BRIEF DESCRIPTION OF THE DRAWINGS

FIG. 1 comprises a flow chart of a first module of the computer program which operates the novel system.

FIG. 2 comprises a flow chart of a second module of the computer program which operates the novel system.

FIGS. 3a and 3b together comprise a flowchart of a third module of the computer program which operates the novel system. A small diagram near the top of FIG. 3b (page 4/12) shows the geometrical relationship of FIGS. 3a and 3b.

FIGS. 4a and 4b together comprise a flowchart of a fourth module of the computer program which operates the novel system. A small diagram near the top of FIG. 4b (page 6/12) shows the geometrical relationship of FIGS. 4a and 4b.

FIGS. 5a and 5b together comprise a flowchart of a fourth module of the computer program which operates the novel system. A small diagram near the top of FIG. 5b (page 8/12) shows the geometrical relationship of FIGS. 5a and 5b.

FIGS. 6a and 6b together comprise a flowchart of a fourth module of the computer program which operates the novel system. A small diagram near the top of FIG. 6b (page 10/12) shows the geometrical relationship of FIGS. 6a and 6b.

FIGS. 7a and 7b together comprise a flowchart of a fourth module of the computer program which operates the novel system. A small diagram near the top of FIG. 7b (page 12/12) shows the geometrical relationship of FIGS. 7a and 7b.

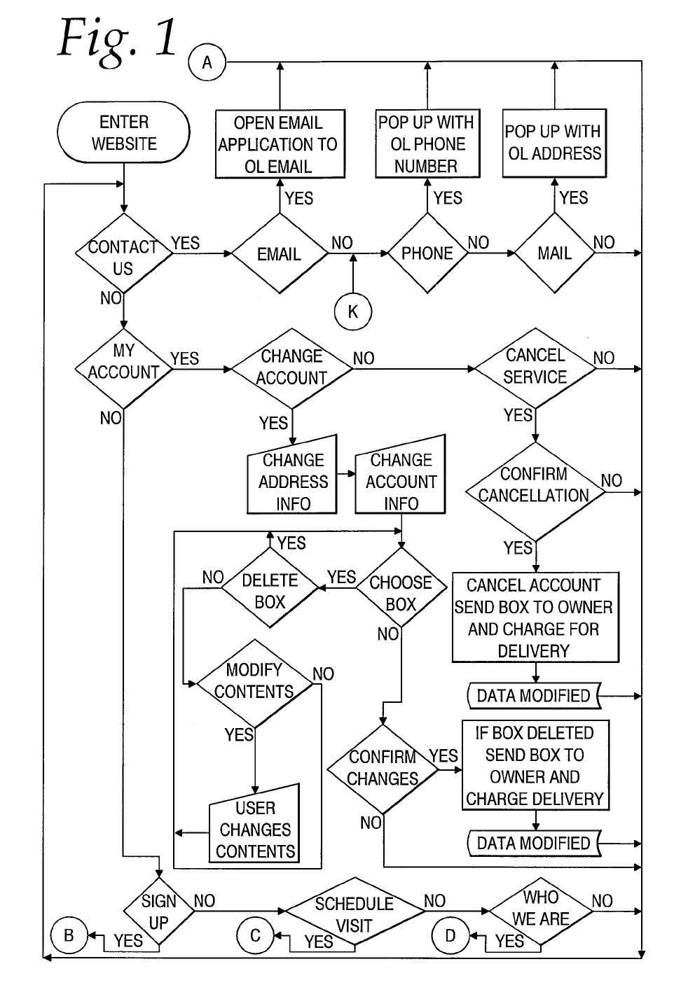

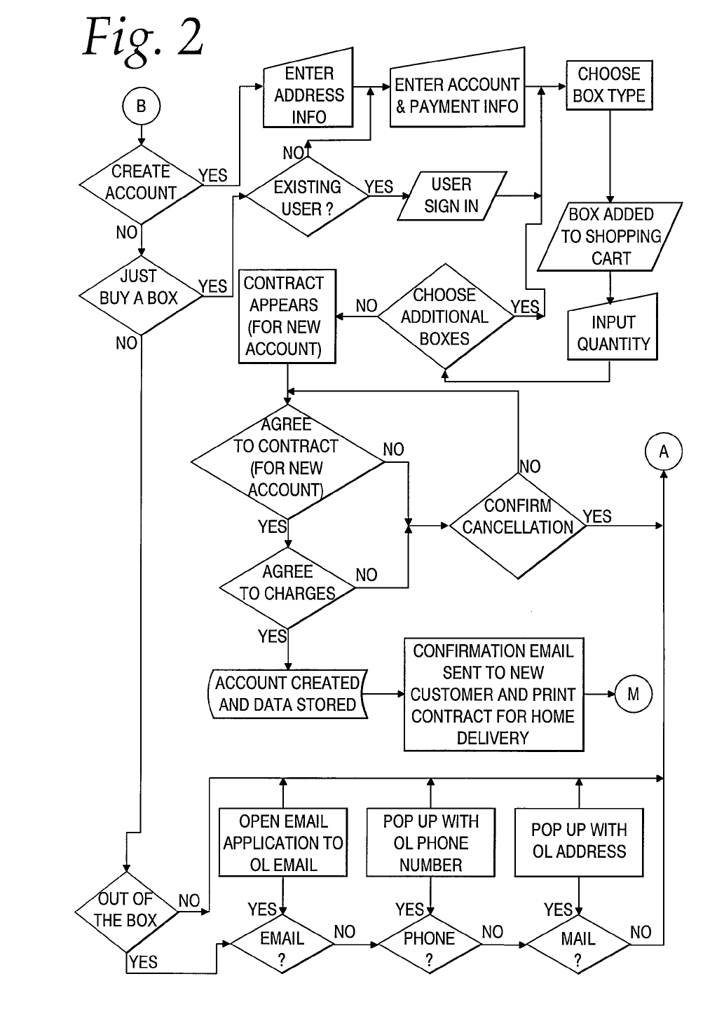

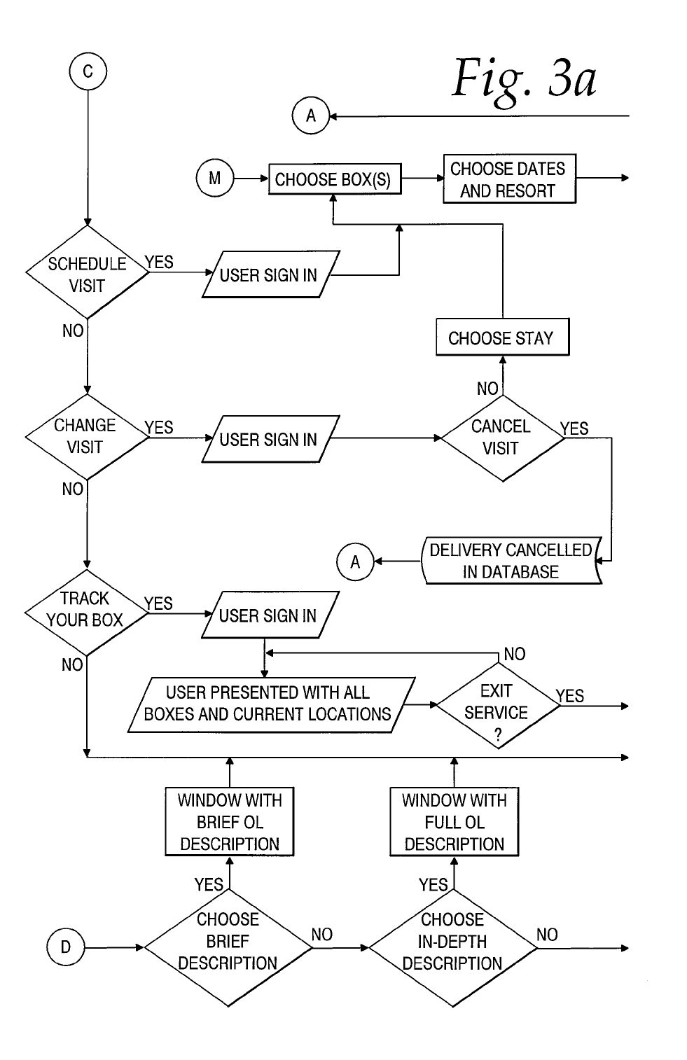

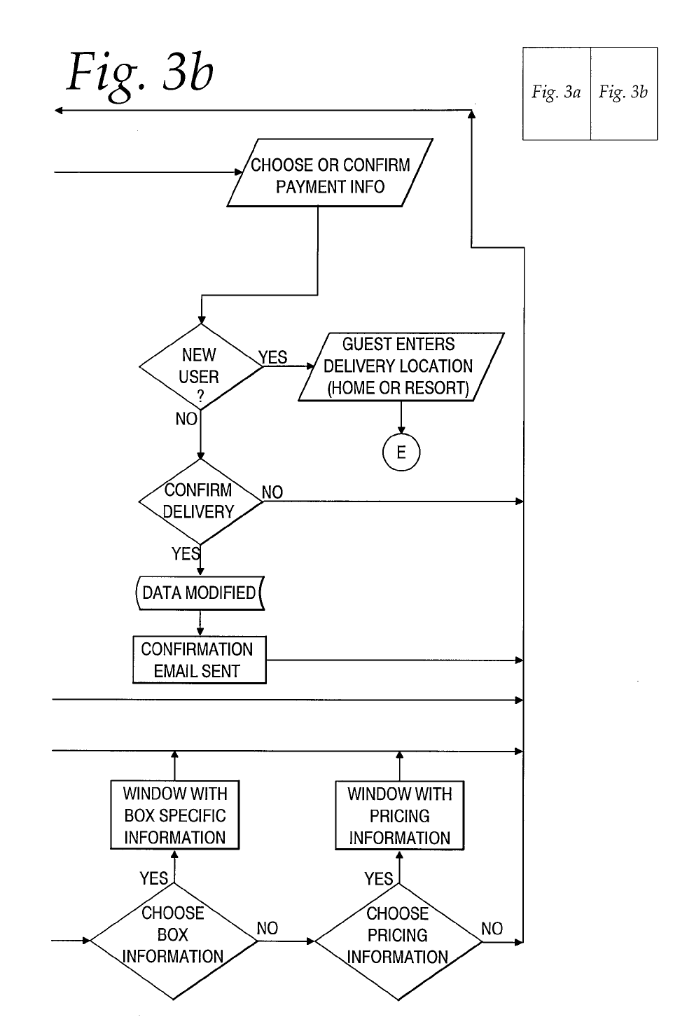

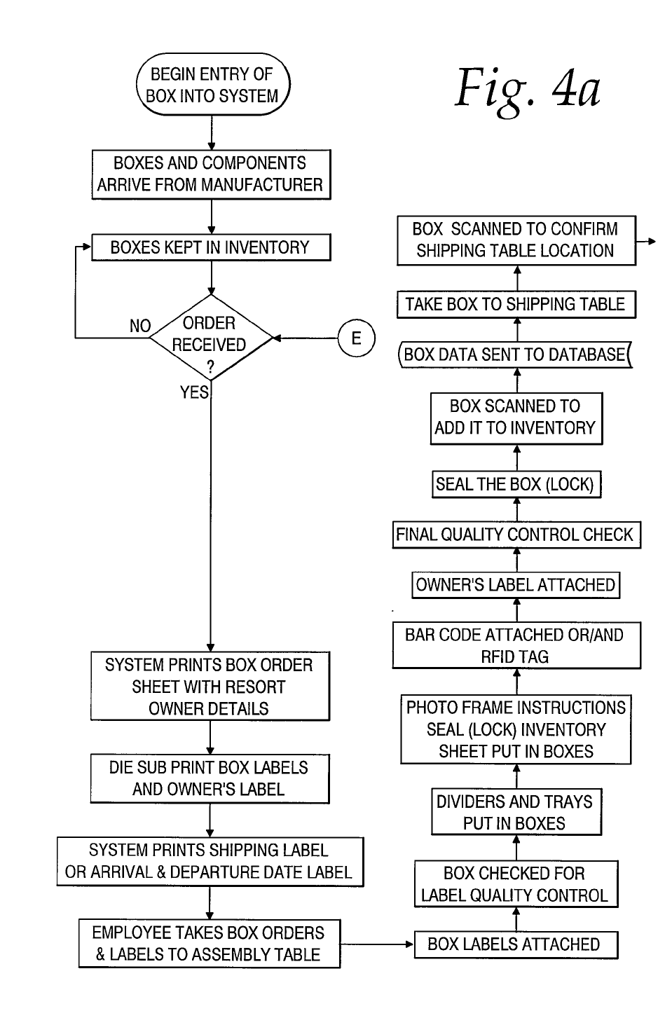

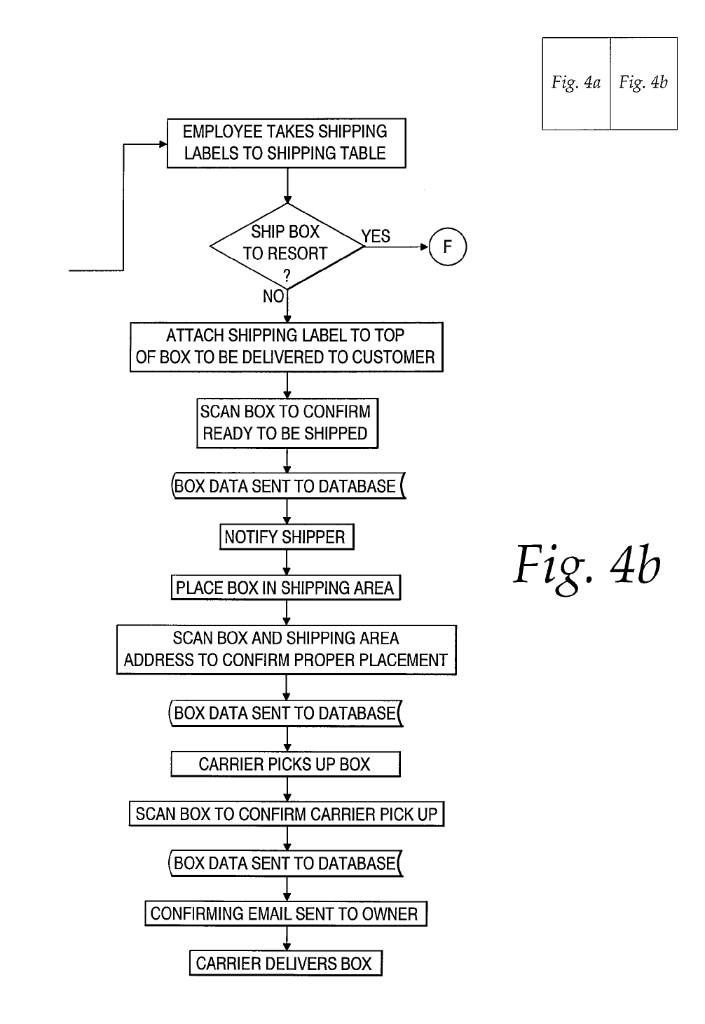

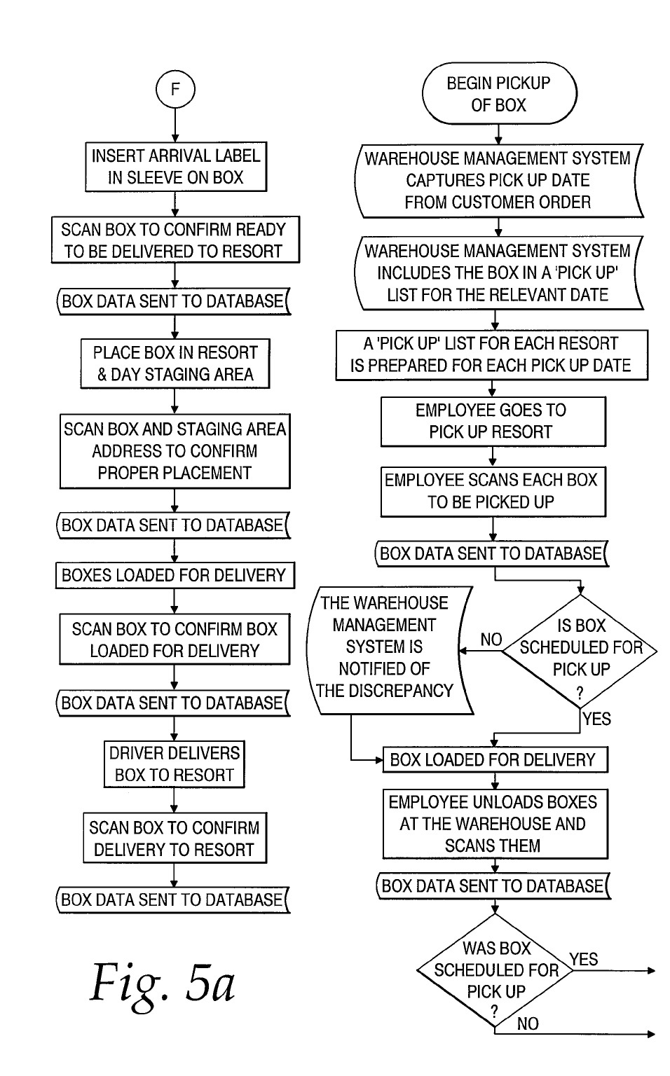

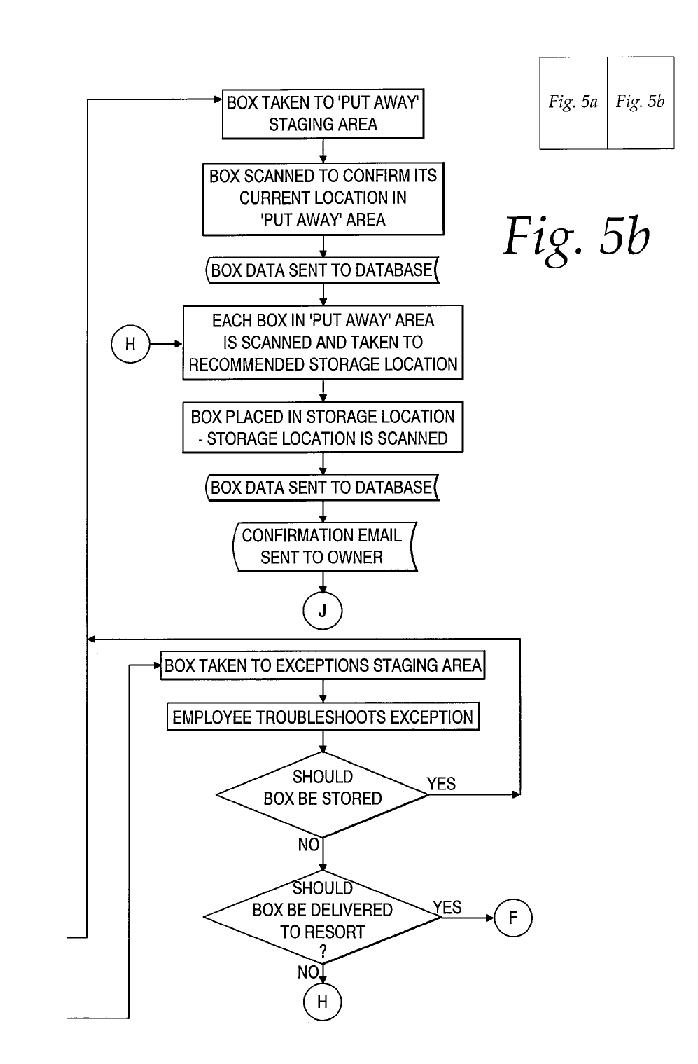

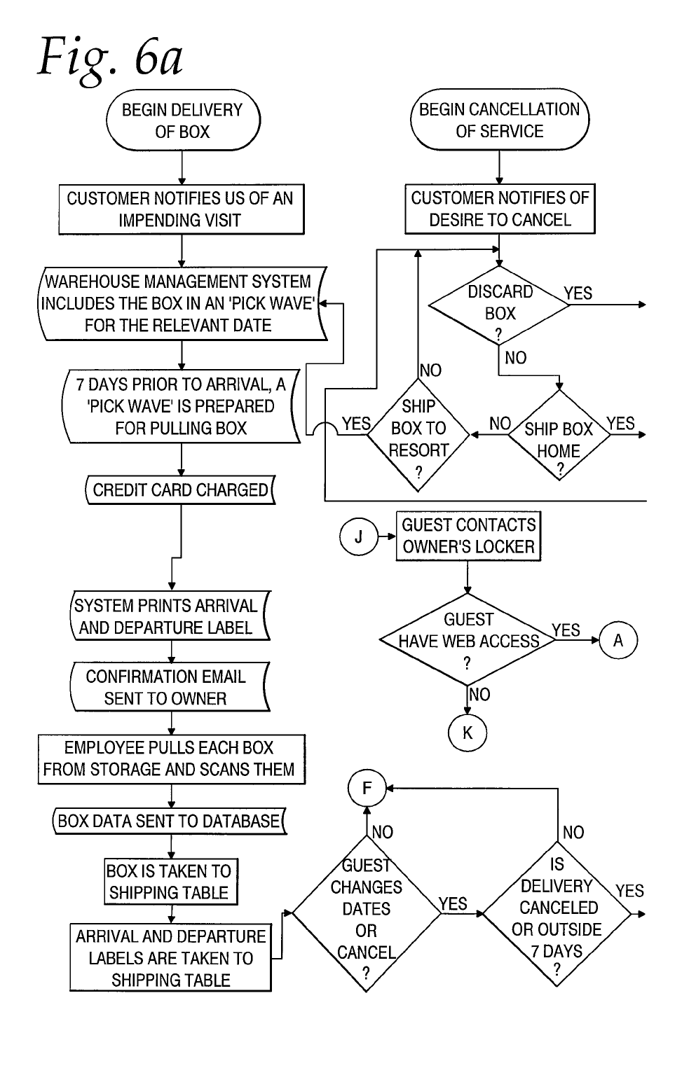

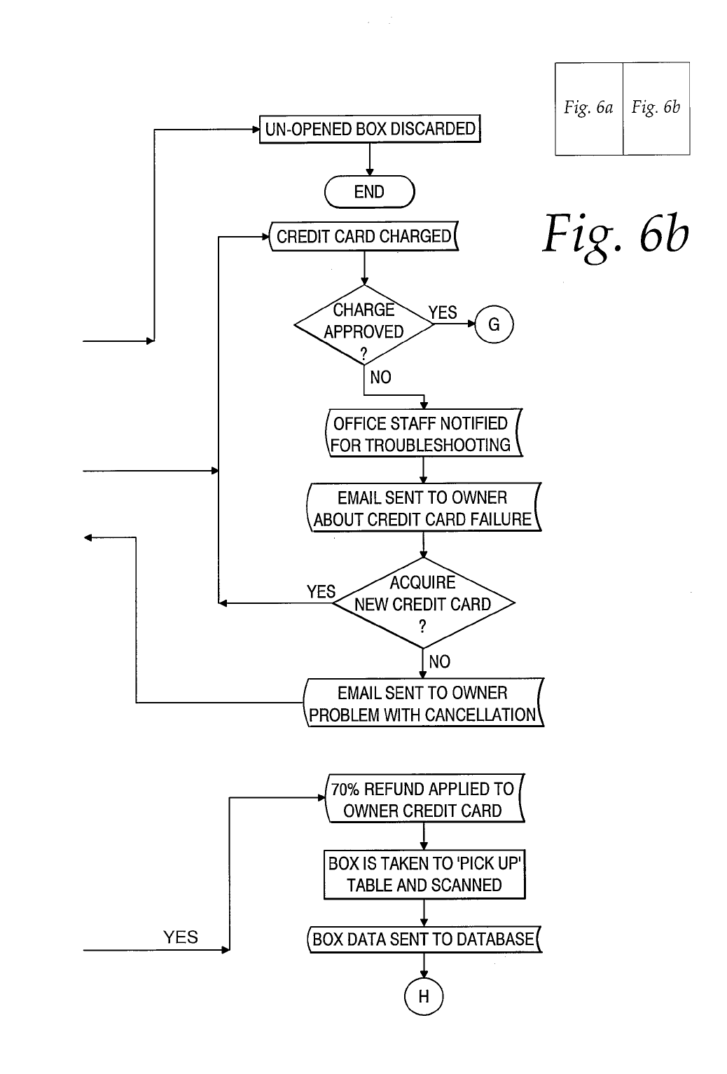

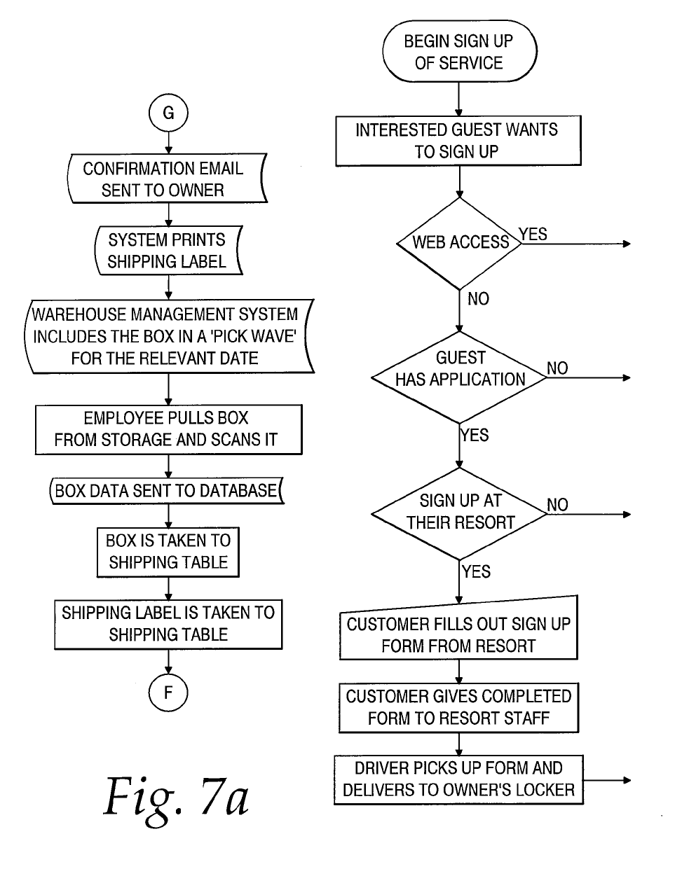

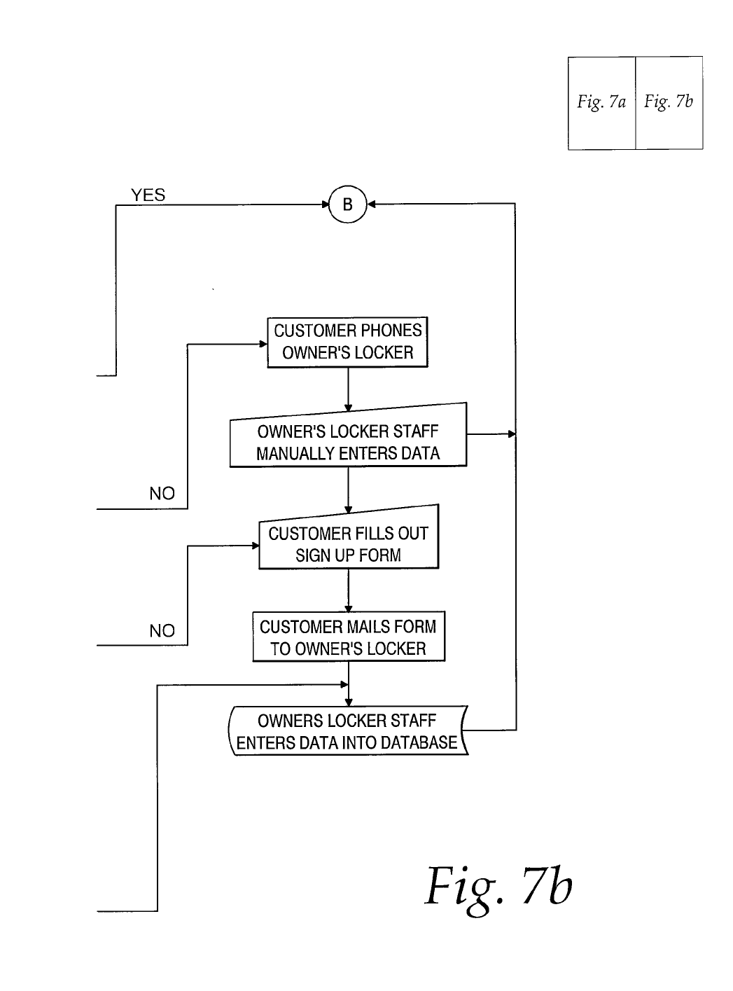

Transit points between the various modules are indicated by letters within circles.

### DESCRIPTION OF THE DRAWINGS

The Figures comprising the drawings constitute a flow chart illustrating the software which operates the invention.

This method, computer program and website allow an individual to contact the company by e-mail, telephone, fax or mail.

This computer program and website also allow a client to access the account details they have created using a user name and password.

The method, computer program and website allow clients to alter their account details when they have entered the correct user name and password.

It is another object of the present invention to provide a method, computer program and website which allows clients to cancel their contract and specify whether they would like their items delivered to them or destroyed.

The present invention provides a method, computer program and website to allow clients to access a confidential, on-line inventory of the items contained in their storage container and modify it if required.

Still the present invention provides a method, computer program and website to allow clients to cancel some of their existing containers or add additional containers to the items being stored.

The method, computer program and website allow potential clients to sign up for the service offered by the company.

The method, computer program and website allow new clients to create accounts with the company consisting of contact and billing details and the creation of a user name and password to allow access to the secure areas of the website.

The present invention provides a method, computer program and website to allow new clients to create a demographic profile detailing their family size, mode of transportation, etc.

The method, computer program and website allow a new client to purchase container(s) for use with the service.

The present invention provides a method, computer program and website to allow new clients to review the terms of a service contract and agree to its terms, conditions and payment procedures.

The present invention provides a method, computer program and website to allow new clients to specify the delivery details of the container(s) they are purchasing.

The present invention provides a method, computer program and website to allow an individual to purchase a container(s) without signing up for the company's storage and delivery service.

The present invention provides a method, computer program and website to allow clients to notify the company of any other item that they might want to be included in the company's storage and delivery service.

The present invention provides a method, computer program and website to allow a client to request to delivery of personal items.

The present invention provides a method, computer program and website to allow a client to specify the date on which the items are to be delivered, and the date on which the items are to be picked up and returned to storage.

The present invention provides a method, computer program and website to allow a client to modify or cancel a previously specified delivery and pick up request.

The present invention provides a method, computer program and website to allow clients to access to tracking data for the personal items contained in the warehouse management system to see the location and every movement of their personal items.

The present invention provides a method, computer program and website to allow an individual to learn about the particular details of the services provided by the company.

The present invention provides a method, computer program and website to allow a potential client to choose to view a brief description of the services provided by the company.

The present invention provides a method, computer program and website to allow a potential client to choose to view a more detailed description and series of vignettes and testimonials detailing the service provided by the company.

The present invention provides a method, computer program and website to allow a potential client to choose to view details, including three-dimensional renderings of the various containers available from the company.

The present invention provides a method, computer program and website to allow a potential client to choose to view details of the various pricing options for the containers and the delivery and storage service.

It is another object of the present invention to provide a separate, operable computer program to monitor and record the location and every movement of each container or other item stored by the company. This warehouse management system maintains tables which reside on the company's SQL Server database server. These tables duplicate certain data entered through the website. An account is created when a client signs up for the service. Delivery lists are compiled as clients schedule visits and pick up lists are also compiled as clients schedule visits.

The present invention utilizes a unique flash-based website through which clients and potential clients can easily navigate the main functions: contact us; my account; sign up; schedule a visit; and who we are. The website also incorporates the logo of any resort company that the company has a strategic relationship with and features list of the respective resort company resorts from which clients of that resort company can choose.

The present invention utilizes a container that is made of injection molded plastic whose dimensions are 23½″×19½×″×13″. The container has a detachable lid. The container also has removable dividers in the bottom and contains a removable, clear plastic small item storage box. The container and the small item storage box are available commercially, although the color of the container is custom. The dividers are also available commercially, though not in their custom color. They have also been altered as to size to facilitate their configuration. The colored container, with the dividers configured and small item storage box is unique.

It is another object of the present invention to provide a separate operable computer program that receives orders from clients for containers as they are entered into the website.

This program generates a container order sheet with the client's personal details and the name of the resort company the client owns a vacation home interest with. This program also generates clear labels for the sides of the box with the resort company logo and the individual resort as well as a label with the client's personal details. This program also prints either a shipping label (if the container is to be shipped to the client's home) or a 4″×6″ card with the client's name as well as the resort they will be visiting and their arrival and departure dates.

The present invention calls for the container to be assembled and customized once the order is received. An employee takes the printed container order and assembles a container from components in inventory including the configured dividers and the small item case. The labels which have been printed are attached to the sides of the container. A bar code, and/or Radio Frequency Identification tag are attached to the container. A label detailing the client's name is attached to the container and the box is sealed for shipping.

The present invention calls for the completed container to then be added to the warehouse management system. This is accomplished through a separate operable computer program, the warehouse management system. The warehouse management system receives a copy of certain data entered by a client in the website. Separate tables are created within the warehouse management system and this data is married to the identification tag that is attached to the container when the container is scanned for the first time.

The present invention then calls for the completed box to be shipped to the client. If, in the order the client placed through the website, they have specified that the box is to be shipped to their home, a shipping label is attached and the box is shipped. The warehouse management system notifies the shipper when the box is scanned indicating it is ready to be shipped. The box is scanned again as it is placed in the shipping area and is scanned again when it is picked up by the carrier.

If, in the order the client placed through the website, they have specified that the box is to be shipped to their chosen resort on the next visit, an arrival/departure card is inserted into the plastic sleeve on the container. The delivery data is captured by the warehouse management system which adds the new container to the list of other containers to be delivered on the relevant date. The container is scanned to confirm it is ready to be delivered, is scanned when it is loaded for delivery and is scanned again when it is delivered to the client's resort.

The present invention accumulates data for the delivery of containers as clients enter their arrival dates as a part of the process where they schedule a visit. The warehouse management system creates a pick wave of all containers to be delivered by date. Seven days prior to the scheduled delivery date, the client's credit card is charged for the delivery and pick up service and the warehouse management system sends an e-mail to the client from their container: “I'm ready to go to (name of resort) and I hope you are too. Please look at your on-line inventory to see the items you have in your container to assist you in packing for your trip.” The warehouse management system also generates a pick wave for that date and cards listing the owner's name and arrival and departure date for each container.

The present invention then calls for an employee to take the pick wave list and pull each container on the list from its warehouse location and scan it to confirm that it has been removed from storage. The containers are taken to the shipping table where the arrival and departure cards are inserted into a plastic sleeve of the end of the container. The box is then placed in the appropriate staging area and scanned so that the warehouse management system notes its location. The container is scanned again as it is loaded for delivery and again when it is delivered.

The present invention accumulates data for the pickup of containers as clients enter their departure date as part of the process where they schedule a visit. The warehouse management system includes the container in a pickup list for the relevant date and generates a list of containers to be picked up by location for that date.

The present invention then calls for an employee to go to each location and pick up each container on the list, scanning it to indicate that it has been picked up. Each container is then scanned again as it is unloaded at the storage facility and is placed in a put-away staging area. The box is then scanned again and the warehouse management system suggests where the box should be placed in the warehouse based on its velocity (i.e. how often the client has recently had their container delivered). When the box is placed back into storage, its position is noted by the warehouse management system and an e-mail is automatically sent to the client from their container: “I made it home safely and I hope you did, too. Please go to our website and update your on-line inventory so you'll know what is in your container when you are packing for your next visit”.

1. A method for receiving, storing, retrieving and delivering a client's personal items in at least one container on request, the method comprising the steps of
providing a computer system capable of being contacted by a client,
permitting the client to instruct the computer system to order delivery of the individual's container to a certain place at a certain time,
permitting the customer to instruct the computer system to order pick-up of the client's container at a certain time, and
storing the container at a location identified in the computer system's memory.

2. A method according to claim 1 for the comprising the steps of
permitting the client to access information about the client's account.

3. A method according to claim 1 comprising the steps of permitting a client to cancel his contract and to specify whether the client wants items stored in the individual's container to be delivered to the client or to be destroyed.

4. A method according to claim 1 comprising the steps of permitting a client to access a confidential, on-line inventory of items which are contained in the client's storage container.

5. A method according to claim 5 comprising the steps of permitting the client to modify the online inventory of items contained in the client's storage container.

6. A method according to claim 1 comprising the steps of creating a contract via the computer system between the business method operator of the method and the client, and modifying the contract so as to add or delete containers associated with the client.

7. A method according to claim 1 comprising the step of permitting the client to create a demographic profile of the client in the computer system.

8. A method according to claim 1 comprising the step of permitting the client to purchase containers for use in connection with the method,

9. A method according to claim 8 comprising the step of permitting the client to modify information regarding the pickup and the delivery of the containers which the client has purchased.

10. A method according to claim 1 comprising the steps of permitting the client to specify the date upon which the client's container is to be delivered, and permitting the client to specify the date upon which the client's container is to be picked up.

11. A method according to claim 10 comprising the step of permitting the client to modify or cancel a previously specified delivery or pick-up request.

12. A method according to claim 1 comprising the step of permitting the client to obtain information, via the computer system, about the business method operator and about the business method.

13. A method according to claim 1 including the step of permitting a potential client to choose to view details, including three-dimensional renderings, of various containers available from the business method operator.

14. A method according to claim 13 including the method of permitting a potential client to choose to view details of various pricing options for the containers and for the delivery and storage service.

15. A method of receiving, storing and delivering multiple clients' personal items stored in containers on request, the method comprising the steps of
providing a computer system capable of being contacted by multiple clients,
permitting multiple clients to instruct the computer system regarding delivery and pick-up of client's containers, and
causing the computer system to develop container pickup and delivery schedules.

16. A method of receiving, storing and delivering multiple clients' personal items stored in containers on request, the method comprising the steps of
providing a computer system capable of being contacted by multiple clients,
permitting multiple clients to instruct the computer system regarding delivery and pick-up of client's containers, and
causing the computer system to develop inventories of personal items stored in individual containers, and
causing the computer system to associate individual containers and individual inventories with individual clients.
